(19) United States
(12) Patent Application Publication
(10) Pub. No.: US 2022/0165035 A1
(43) Pub. Date: May 26, 2022

(54) LATENCY INDICATOR FOR EXTENDED REALITY APPLICATIONS

(71) Applicant: AT&T Intellectual Property I, L.P., Atlanta, GA (US)

(72) Inventors: Zhi Cui, Sugar Hill, GA (US); James H. Pratt, Round Rock, TX (US); John Oetting, Zionsville, PA (US); Roger Wickes, Gainesville, GA (US)

(21) Appl. No.: 17/103,873

(22) Filed: Nov. 24, 2020

(51) Int. Cl. G06T 19/00; G06T 3/40; H04L 12/26; H04L 29/06; H04L 29/08

(52) U.S. Cl. CPC G06T 19/006; G06T 3/40; H04L 43/106; G02B 27/0172; H04L 65/601; H04L 65/80; H04L 67/36; H04L 43/0852

(57) ABSTRACT

In one example, a method performed by a processing system including at least one processor includes receiving an extended reality stream from a remote server over a network connection, presenting an extended reality experience to a user endpoint device by playing back the extended reality stream, measuring a latency of the network connection between the processing system and the remote server, and displaying a visual indicator of the latency that was measured on a display of the user endpoint device.

The present disclosure relates generally to extended reality (XR) media, and relates more particularly to devices, non-transitory computer-readable media, and methods for providing latency indicators for extended reality applications.

### BACKGROUND

Extended reality (XR) is an umbrella term that encompasses various types of immersive technology in which the real-world environment is enhanced or augmented with virtual, computer-generated objects. For instance, technologies such as virtual reality (VR), augmented reality (AR), and mixed reality (MR) all fall within the scope of XR. XR technologies may be used to enhance entertainment experiences (e.g., gaming, movies, and the like), educational and/or professional development (e.g., training simulations, virtual meetings, and the like), and travel (e.g., virtual or guided tours of museums and historic sites, and the like).

### SUMMARY

In one example, a method performed by a processing system including at least one processor includes receiving an extended reality stream from a remote server over a network connection, presenting an extended reality experience to a user endpoint device by playing back the extended reality stream, measuring a latency of the network connection between the processing system and the remote server, and displaying a visual indicator of the latency that was measured on a display of the user endpoint device.

In another example, a non-transitory computer-readable medium stores instructions which, when executed by a processing system in a telecommunications network, cause the processing system to perform operations. The operations include receiving an extended reality stream from a remote server over a network connection, presenting an extended reality experience to a user endpoint device by playing back the extended reality stream, measuring a latency of the network connection between the processing system and the remote server, and displaying a visual indicator of the latency that was measured on a display of the user endpoint device.

In another example, a device includes a processor and a computer-readable medium storing instructions which, when executed by the processor, cause the processor to perform operations. The operations include receiving an extended reality stream from a remote server over a network connection, presenting an extended reality experience to a user endpoint device by playing back the extended reality stream, measuring a latency of the network connection between the processing system and the remote server, and displaying a visual indicator of the latency that was measured on a display of the user endpoint device.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates a flowchart of a method for presenting an XR experience with a visual latency indicator, in accordance with the present disclosure;

FIG. 3A illustrates one example of the format of a standard Internet control message protocol traceroute message according to the Internet Society Request for Comments 1393;

FIG. 3B illustrates one example of the format of an enhanced Internet control message protocol traceroute message, according to aspects of the present disclosure;

FIG. 4, for example, illustrates an example visual indicator for indicating connection latency that may be visualized as a metronome; and

FIG. 5 depicts a high-level block diagram of a computing device specifically programmed to perform the functions described herein.

To facilitate understanding, identical reference numerals have been used, where possible, to designate identical elements that are common to the figures.

### DETAILED DESCRIPTION

In one example, the present disclosure improves XR experiences by providing a latency indicator. As discussed above, XR technologies such as virtual VR, AR, and MR may be used to enhance entertainment experiences (e.g., gaming, movies, and the like), educational and/or professional development (e.g., training simulations, virtual meetings, and the like), and travel (e.g., virtual or guided tours of museums and historic sites, and the like). XR information can be presented in multiple sensory modalities, including the visual, auditory, haptic, somatosensory, and olfactory modalities. As such, XR can be used to enhance a user's enjoyment of a media by making the media experience more immersive.

XR applications typically demand not just high download speeds (for downloading remote XR content), but also high bandwidth and low latency. Low latency, in particular, may be vital to user comfort. For instance, many XR applications adapt the content that is displayed to the user in a manner that is responsive to the user's movements and field of view. As an example, a user who is wearing a head mounted display (HMD) to watch a 360 degree video may see the landscape of the video that is presented on the display change as he moves his head or turns his body, much as his view of the real world would change with the same movements. Low latency ensures that the view on the display changes smoothly, as the user's view of the real world would. If latency is high, however, there may be a delay between when the user moves his head and when the view on the display changes. This disconnect between what the user feels and what the user sees can cause physical disorientation and discomfort, including vertigo, dizziness, nausea, and the like. The disconnect could also exacerbate pre-existing user conditions, such as seizure disorders and sensory sensitivities. Thus, an issue that might simply be annoying in a non-XR application could have negative physical consequences for the user in an XR application.

Examples of the present disclosure provide a novel technique for a user endpoint device to measure the latency of a network connection between the user endpoint device and a remote device (e.g., an application server) presenting an extended reality experience on the user endpoint device. Further examples of the disclosure provide a unique visual indicator on a display of the user endpoint device to alert the user to the current latency conditions, so that the user can easily detect when high latency may make for a poor XR experience.

In one example, the latency of the connection is measured by making use of previously unused fields in the format of Internet control message protocol (ICMP) traceroute messages exchanged between the user endpoint device and the remote device. In another example, the visual indicator may take the form of a metronome, where various characteristics of the metronome image are varied to convey different parameters of the current latency conditions, as well as other connection conditions (e.g., bandwidth).

Within the context of a present disclosure, an “XR experience” is understood to be a presentation of XR media. For instance, an XR experience could comprise a multi-player XR game, a virtual tour (e.g., of a museum, historical site, real estate, or the like), a training simulation (e.g., for an emergency responder, a vehicle operator, or the like), a meeting (e.g., for professional or educational purposes), an immersive film presentation, or another type of experience. An “XR stream” refers to a stream of data that may contain content and instructions for rendering various components of the XR experience (e.g., video, audio, and other sensory modality files that, when presented to a user, create the XR experience). The XR stream may comprise a prerecorded stream or a dynamic stream that is recorded in real time as the XR experience progresses.

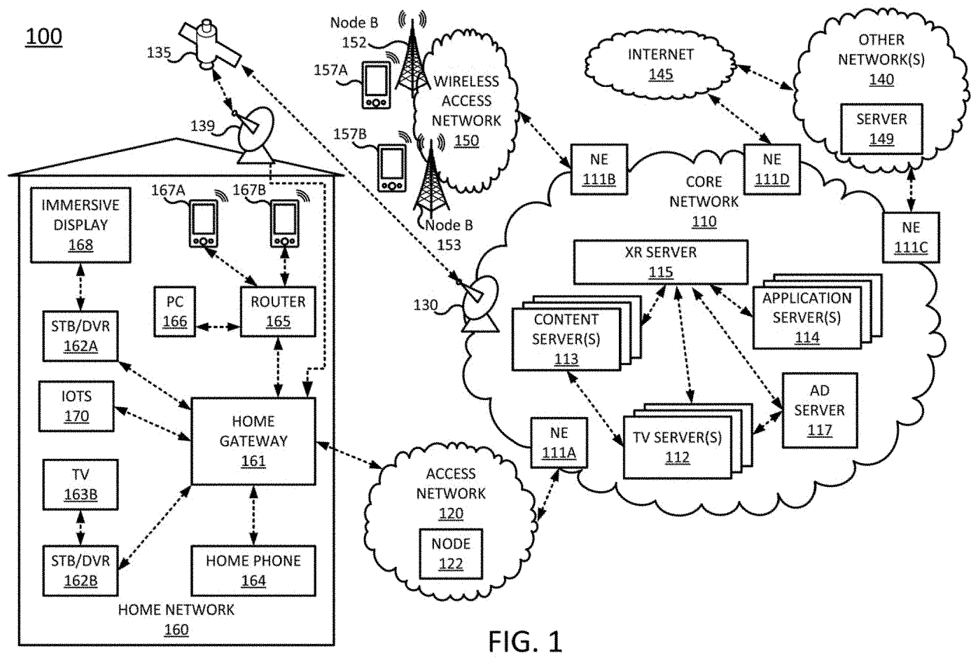

To better understand the present disclosure, FIG. 1 illustrates an example network 100, related to the present disclosure. As shown in FIG. 1, the network 100 connects mobile devices 157A, 157B, 167A and 167B, and home network devices such as home gateway 161, set-top boxes (STBs) 162A, and 162B, television (TV) 163B, home phone 164, router 165, personal computer (PC) 166, immersive display 168, Internet of Things (IoT) devices 170, and so forth, with one another and with various other devices via a core network 110, a wireless access network 150 (e.g., a cellular network), an access network 120, other networks 140 and/or the Internet 145. In some examples, not all of the mobile devices and home network devices will be utilized in presentation of an XR experience with time shifting capabilities. For instance, in some examples, presentation of XR media may make use of the home network devices (e.g., immersive display 168 and/or STB/DVR 162A), and may potentially also make use of any co-located mobile devices (e.g., mobile devices 167A and 167B), but may not make use of any mobile devices that are not co-located with the home network devices (e.g., mobile devices 157A and 157B).

In one example, wireless access network 150 comprises a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, wireless access network 150 may comprise an access network in accordance with any “second generation” (2G), “third generation” (3G), “fourth generation” (4G), Long Term Evolution (LTE) or any other yet to be developed future wireless/cellular network technology including “fifth generation” (5G) and further generations. While the present disclosure is not limited to any particular type of wireless access network, in the illustrative example, wireless access network 150 is shown as a UMTS terrestrial radio access network (UTRAN) subsystem. Thus, elements 152 and 153 may each comprise a Node B or evolved Node B (eNodeB).

In one example, each of mobile devices 157A, 157B, 167A, and 167B may comprise any subscriber/customer endpoint device configured for wireless communication such as a laptop computer, a Wi-Fi device, a Personal Digital Assistant (PDA), a mobile phone, a smartphone, an email device, a computing tablet, a messaging device, a wearable smart device (e.g., a smart watch or fitness tracker), a gaming console, and the like. In one example, any one or more of mobile devices 157A, 157B, 167A, and 167B may have both cellular and non-cellular access capabilities and may further have wired communication and networking capabilities.

As illustrated in FIG. 1, network 100 includes a core network 110. In one example, core network 110 may combine core network components of a cellular network with components of a triple play service network; where triple play services include telephone services, Internet services and television services to subscribers. For example, core network 110 may functionally comprise a fixed mobile convergence (FMC) network, e.g., an IP Multimedia Subsystem (IMS) network. In addition, core network 110 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Core network 110 may also further comprise a broadcast television network, e.g., a traditional cable provider network or an Internet Protocol Television (IPTV) network, as well as an Internet Service Provider (ISP) network. The network elements 111A-111D may serve as gateway servers or edge routers to interconnect the core network 110 with other networks 140, Internet 145, wireless access network 150, access network 120, and so forth. As shown in FIG. 1, core network 110 may also include a plurality of television (TV) servers 112, a plurality of content servers 113, a plurality of application servers 114, an advertising server (AS) 117, and an extended reality (XR) server 115 (e.g., an application server). For ease of illustration, various additional elements of core network 110 are omitted from FIG. 1.

In one example, XR server 115 may generate computer-generated content (e.g., digital overlays which may be combined with a live media including images of a “real world” environment, or entirely digital environments) to produce an extended reality experience. For instance, where the computer-generated content comprises a digital overlay, the computer-generated content may include renderings of virtual objects that do not exist in the real world environment, such as graphics, text, audio clips, and the like. However, when the computer-generated content is synchronized with the live footage of the “real world” environment on an immersive display (e.g., over a live video stream on a television or on a live view through a head mounted display), it may appear to a user that the virtual objects are present in the “real world” environment.

Where the computer-generated content is an entirely digital environment, the entirely digital environment may appear to the user as a simulated environment in which the user may interact with objects and/or other users. In one example, the extended reality experience for which the computer-generated content is rendered is a multi-user experience, such as a multi-player or cooperative video game, an immersive film presentation, a training simulation, a virtual tour or meeting, and/or other types of experience. The computer-generated content may be delivered to one or more user endpoint devices (e.g., one or more of mobile devices 157A, 157B, 167A, and 167B, IoTs 170, the PC 166, the home phone 164, the TV 163B, and/or the immersive display 168) as an XR stream for rendering. The XR stream may include various components of the XR experience, such as a visual component, an audio component, a tactile component, an olfactory component, and/or gustatory component. The different components of the XR stream may be rendered by a single user endpoint device (e.g., an immersive display), or different components may be rendered by different user endpoint devices (e.g., a television may render the visual and audio components, while an Internet-connected thermostat may adjust an ambient temperature).

The XR server 115 may interact with television servers 112, content servers 113, and/or advertising server 117, to select which video programs, or other content and advertisements, if any, to include in an XR experience. For instance, the content servers 113 may store scheduled television broadcast content for a number of television channels, video-on-demand programming, local programming content, gaming content, and so forth. Alternatively, or in addition, content providers may stream various contents to the core network for distribution to various subscribers, e.g., for live content, such as news programming, sporting events, and the like. In one example, advertising server 117 stores a number of advertisements that can be selected for presentation to users, e.g., in the home network 160 and at other downstream viewing locations. For example, advertisers may upload various advertising content to the core network 110 to be distributed to various users. Any of the content stored by the television servers 112, content servers 113, and/or advertising server 117 may be used to generate computer-generated content which, when presented alone or in combination with pre-recorded or real-world content or footage, produces an XR experience.

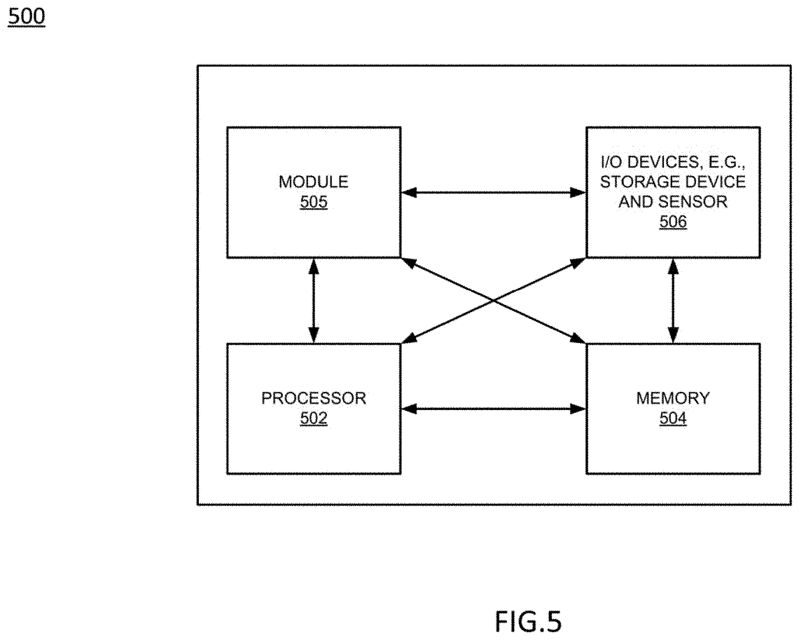

In one example, any or all of the television servers 112, content servers 113, application servers 114, XR server 115, and advertising server 117 may comprise a computing system, such as computing system 500 depicted in FIG. 5.

In one example, any of the user endpoint devices (e.g., mobile devices 157A, 157B, 167A, and 167B, IoTs 170, the PC 166, the home phone 164, the TV 163B, and/or the immersive display 168) may include an application control manager. The application control manager may monitor the performance of the user endpoint device's connection to the XR server 115 and may display a visual indicator of showing the state or condition of various network performance metrics (including at least latency). For instance, the application control manager may “ping” the XR server 115 periodically by sending an enhanced Internet control message protocol (ICMP) traceroute message, described in further detail below, that is used to collect data from which the current latency of the network connection between the user endpoint device and the XR server 115 can be calculated. The application control manager may also display a visual indicator or graphic (e.g., which in one example takes the form of a metronome) to graphically display the current network conditions experienced by the user endpoint device, including the latency of the connection to the XR server 115.

In a further example, the application control manager may further include a machine learning component that is capable of learning the optimal network performance metrics for various XR applications on the user endpoint device. The optimal network performance metrics may be specific not only to particular XR applications, but also to specific users. For instance, a user who is more sensitive to delays in the rendering of a 360 degree video may have a lower latency threshold for a 360 video streaming application than a user who is less sensitive to delays. Thus, the application control manager may learn, for a particular user using a particular application, what the particular user's tolerances are for degradations in network performance metrics. In further examples, the application control manager may also learn, for the particular user, the modifications that can be made to the XR application to improve the user's experience. User tolerances for different XR applications and modifications may be stored in a user profile. The user profile may be stored on the user endpoint device. The application control manager may also have access to third party data sources (e.g., server 149 in other network 140), where the third party data sources may store the user profiles for a plurality of users.

In one example, the access network 120 may comprise a Digital Subscriber Line (DSL) network, a broadband cable access network, a Local Area Network (LAN), a cellular or wireless access network, a 3^{rd} party network, and the like. For example, the operator of core network 110 may provide a cable television service, an IPTV service, or any other type of television service to subscribers via access network 120. In this regard, access network 120 may include a node 122, e.g., a mini-fiber node (MFN), a video-ready access device (VRAD) or the like. However, in another example node 122 may be omitted, e.g., for fiber-to-the-premises (FTTP) installations. Access network 120 may also transmit and receive communications between home network 160 and core network 110 relating to voice telephone calls, communications with web servers via the Internet 145 and/or other networks 140, and so forth.

Alternatively, or in addition, the network 100 may provide television services to home network 160 via satellite broadcast. For instance, ground station 130 may receive television content from television servers 112 for uplink transmission to satellite 135. Accordingly, satellite 135 may receive television content from ground station 130 and may broadcast the television content to satellite receiver 139, e.g., a satellite link terrestrial antenna (including satellite dishes and antennas for downlink communications, or for both downlink and uplink communications), as well as to satellite receivers of other subscribers within a coverage area of satellite 135. In one example, satellite 135 may be controlled and/or operated by a same network service provider as the core network 110. In another example, satellite 135 may be controlled and/or operated by a different entity and may carry television broadcast signals on behalf of the core network 110.

In one example, home network 160 may include a home gateway 161, which receives data/communications associated with different types of media, e.g., television, phone, and Internet, and separates these communications for the appropriate devices. The data/communications may be received via access network 120 and/or via satellite receiver 139, for instance. In one example, television data is forwarded to set-top boxes (STBs)/digital video recorders (DVRs) 162A and 162B to be decoded, recorded, and/or forwarded to television (TV) 163B and/or immersive display 168 for presentation. Similarly, telephone data is sent to and received from home phone 164; Internet communications are sent to and received from router 165, which may be capable of both wired and/or wireless communication. In turn, router 165 receives data from and sends data to the appropriate devices, e.g., personal computer (PC) 166, mobile devices 167A and 167B, IoT devices 170, and so forth. In one example, router 165 may further communicate with TV (broadly a display) 163B and/or immersive display 168, e.g., where one or both of the television and the immersive display incorporates “smart” features. In one example, router 165 may comprise a wired Ethernet router and/or an Institute for Electrical and Electronics Engineers (IEEE) 802.11 (Wi-Fi) router, and may communicate with respective devices in home network 160 via wired and/or wireless connections.

It should be noted that as used herein, the terms “configure” and “reconfigure” may refer to programming or loading a computing device with computer-readable/computer-executable instructions, code, and/or programs, e.g., in a memory, which when executed by a processor of the computing device, may cause the computing device to perform various functions. Such terms may also encompass providing variables, data values, tables, objects, or other data structures or the like which may cause a computer device executing computer-readable instructions, code, and/or programs to function differently depending upon the values of the variables or other data structures that are provided. For example, one or both of the STB/DVR 162A and STB/DVR 162B may host an operating system for presenting a user interface via TVs 163B and/or immersive display 168, respectively. In one example, the user interface may be controlled by a user via a remote control or other control devices which are capable of providing input signals to a STB/DVR. For example, mobile device 167A and/or mobile device 167B may be equipped with an application to send control signals to STB/DVR 162A and/or STB/DVR 162B via an infrared transmitter or transceiver, a transceiver for IEEE 802.11 based communications (e.g., “Wi-Fi”), IEEE 802.15 based communications (e.g., “Bluetooth”, “ZigBee”, etc.), and so forth, where STB/DVR 162A and/or STB/DVR 162B are similarly equipped to receive such a signal. Although STB/DVR 162A and STB/DVR 162B are illustrated and described as integrated devices with both STB and DVR functions, in other, further, and different examples, STB/DVR 162A and/or STB/DVR 162B may comprise separate STB and DVR components.

Those skilled in the art will realize that the network 100 may be implemented in a different form than that which is illustrated in FIG. 1, or may be expanded by including additional endpoint devices, access networks, network elements, application servers, etc. without altering the scope of the present disclosure. For example, core network 110 is not limited to an IMS network. Wireless access network 150 is not limited to a UMTS/UTRAN configuration. Similarly, the present disclosure is not limited to an IP/MPLS network for VoIP telephony services, or any particular type of broadcast television network for providing television services, and so forth.

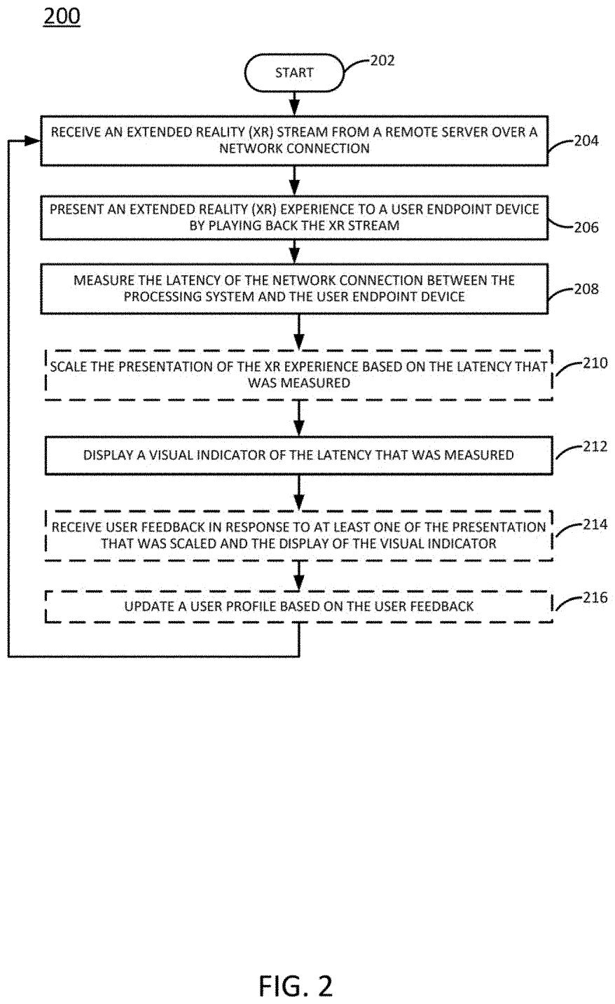

To further aid in understanding the present disclosure, FIG. 2 illustrates a flowchart of a method 200 for presenting an XR experience with a visual latency indicator, in accordance with the present disclosure. In one example, the method 200 may be performed by a user endpoint device that is configured to present an XR experience using XR streams provided by an application server or other sources. For instance, the user endpoint device could be any of the mobile devices 157A, 157B, 167A, and 167B, IoTs 170, the PC 166, the home phone 164, the TV 163B, and/or the immersive display 168) illustrated in FIG. 1, and may be configured to receive XR streams from the XR server 115 of FIG. 1. However, in other examples, the method 200 may be performed by another device, such as the processor 502 of the system 500 illustrated in FIG. 5.

The method 200 begins in step 202. In step 204, the processing system may receive an extended reality (XR) stream from a remote server (e.g., XR server 115) over a network connection. The XR stream may include one or more components for playback on the user endpoint device. For instance, the XR stream may comprise a computer-generated visual overlay that the user endpoint device renders for superimposition over a view of the surrounding real world environment, may comprise a computer-generated audio track to be played while viewing a real word, computer-generated, or hybrid environment. In some examples, additional XR streams may be sent by the remote server to co-located devices (e.g., IoT devices within some predefined geographic distance of the user endpoint device) to alter the ambient conditions in the real world environment (e.g., dim the lighting, raise the temperature, lower the volume of the audio, etc.) while the user endpoint device presents the received XR stream. In another example, the XR stream may comprise an entirely virtual environment that the user endpoint device renders for presentation in place of a view of the real world environment.

In step 206, the processing system may present an extended reality (XR) experience to a user endpoint device by playing back the XR stream. As discussed above, the XR experience may comprise a multi-player video game, a virtual tour, a meeting, an immersive film, or another type of XR experience. In one example, the user endpoint device may include one or more of: an immersive display, a mobile phone, a computing device, or any other device that is capable of rendering an XR environment. Different components of the XR stream may be played back on different user endpoint devices to present the full XR experience.

In step 208, the processing system may measure the latency of the network connection between the processing system and the user endpoint device. In one example, the processing system measures the latency by sending a network slice-specific and access network-specific ping to the remote server that utilizes network slice selection assistance information (S-NSSAI) and an enhanced ICMP traceroute message. In particular, one example of the present disclosure utilizes previously unused fields of the standard ICMP traceroute message to convey data from which the latency can be measured.

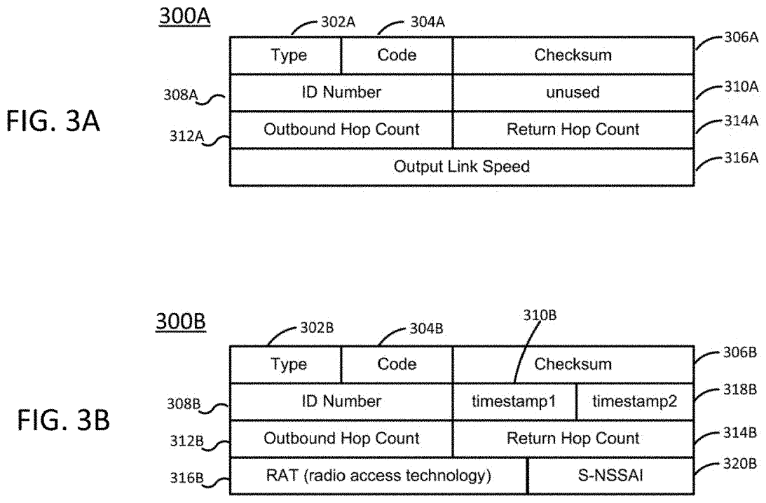

FIG. 3A, for instance, illustrates one example of the format of a standard ICMP traceroute message 300A according to the Internet Society (ISOC) Request for Comments (RFC) 1393, while FIG. 3B illustrates one example of the format of an enhanced ICMP traceroute message 300B, according to aspects of the present disclosure.

As illustrated in FIG. 3A, the format of the standard ICMP traceroute message 300A includes a plurality of fields 302A-316A. These fields may more specifically include a type field 302A (e.g., an eight-bit field typically set to thirty), a code field 304A (e.g., an eight-bit field for containing a zero when the traceroute message is successfully forwarded and a one when the traceroute message is discarded for lack of route), a checksum field 306A (e.g., a sixteen-bit field for a computed checksum for the traceroute message), an ID number field 308A (e.g., a sixteen-bit field for providing an arbitrary number, unrelated to the ID number in the IP header, used by the user endpoint device to identify the ICMP traceroute message), an unused field 310A (e.g., a sixteen-bit field containing no data), an outbound hop count field 312A (e.g., a sixteen-bit field for tracking the number of routers through which the outbound ICMP traceroute message passes, not including the remote server), a return hop count field 314A (e.g., a sixteen-bit field for tracking the number of routers through which the return ICMP traceroute message passes, not including the user endpoint device), and an output link speed field 316A (e.g., a thirty-two-bit field for providing the speed, in bytes per second, of the link over which the return traceroute message will be sent).

As illustrated in FIG. 3B, the format of the disclosed enhanced ICMP traceroute message 300B is similar to the format of the standard ICMP traceroute message 300A in several respects. For instance, the enhanced ICMP traceroute message 300B includes a plurality of fields 302B-318B. These fields include a type field 302B, a code field 304B, a checksum field 306B, an ID number field 308B, an outbound hop count field 312B, and a return hop count field 314B, all of which serve the purposes described above with respect to the corresponding fields of the standard ICMP traceroute message 300A.

However, the enhanced ICMP traceroute message 300B also modifies the format of the standard ICMP traceroute message 300A in several ways. For one, the enhanced ICMP traceroute message 300B replaces the unused field 310A of the standard ICMP traceroute message 300A with two new fields: a timestamp1 field 310B and a timestamp2 field 318B. In one example, each of the timestamp1 field 310B and the timestamp2 field 318B comprises eight-bit fields. The timestamp1 field 310B may be for providing a first timestamp indicative of a time at which the user endpoint device sends the enhanced ICMP traceroute message 300B to the remote server. The timestamp2 field 318B may be for providing a second timestamp indicative of a time at which the remote server receives the enhanced ICMP traceroute message 300B from the user endpoint device.

In addition, the enhanced ICMP traceroute message 300B replaces the outbound link speed field 316A of the standard ICMP traceroute message 300A with two new fields: a radio access technology (RAT) field 316B and a S-NSSAI field 320B. In one example, the radio access technology (RAT) field 316B is a twenty-bit field. The radio access technology (RAT) field 3166 may be for providing information about the type of radio access network that the user endpoint device uses to connect to the core network, and, thus, the remote server (e.g., 4G, 5G, Wifi, etc.).

In one example, the S-NSSAI field 320B is a twelve-bit field. The S-NSSAI field 3320B may contain an identifier of a network slice that is allocated to the user endpoint device.

The enhanced ICMP traceroute message 300B may be employed in connection with step 208 as follows. The processing system may send an outbound enhanced ICMP traceroute message (such as the enhanced ICMP traceroute message 300B) to the remote server. The outbound enhanced ICMP traceroute message may contain, in the timestamp1 field 310B, the time at which the processing system sent the outbound enhanced ICMP traceroute message. When the remote server returns the outbound enhanced ICMP traceroute message to the processing system as a return enhanced ICMP traceroute message, the return enhanced ICMP traceroute message may contain, in the timestamp2 field 3186, the time at which the remote server received the outbound enhanced ICMP traceroute message. Thus, when the processing system receives the return enhanced ICMP traceroute message, the processing system may be able to calculate how long it took the outbound enhanced ICMP traceroute message to travel from the processing system to the remote server based on the time difference between the timestamps contained in the timestamp1 field 310B and the timestamp2 field 318B. The time that it took the outbound enhanced ICMP traceroute message to travel from the processing system to the remote server is indicative of the latency of the network connection between the processing system and the remote server.

Referring back to FIG. 2, in optional step 210 (illustrated in phantom), the processing system may scale the presentation of the XR experience based on the latency that was measured in step 208. For instance, if the processing system determines that the current latency (as measured in step 208) is above a predefined threshold latency (e.g., x milliseconds), or is degrading by more than a predefined threshold rate (e.g., has degraded by more than x milliseconds over the last y seconds or minutes), then the processing system may take an action to scale the XR experience. In one example, machine learning techniques may be employed to determine when to take action. For instance, machine learning techniques may be employed to learn when the measured latency warrants intervention (which may be based not only on the measured latency but also on tolerances of the user, which may be specified in a user profile as described above), as well as what types of intervention are most likely to be effective (e.g., effective in rendering an XR experience that is compatible with the user's tolerances).

In one example, this action may involve requesting that network traffic between the processing system and the remote server be rerouted to a route experiencing potentially lower latency. For instance, a profile associated with the processing system may specify that a certain portion of the processing system's data allocation (e.g., x out of y gigabytes per month) may be reserved for applications that require latency below a predefined threshold latency. In this case, the processing system may be permitted to be assigned to a different network slice (e.g., a different network slice other than a default network slice to which the processing system is assigned) to use the portion of the data allocation.

In another example, the action may comprise lowering a resolution of the visual component of the XR experience. For instance, certain XR experiences may display the visual component of the XR experience in a manner that adapts to the movement of the user's gaze. As an example, the entire 360 degrees of a 360 degree video may not be rendered in the highest possible resolution; instead, the area on which the user's gaze is focused may be rendered at the highest resolution, while all other areas are rendered in a lower resolution. However, as the user's gaze moves, the area that is rendered at the highest resolution is changed, so that the area on which the user's gaze is focused is always rendered at the highest resolution. Thus, the remote server delivering the 360 degree video may adaptively change the areas of the 360 degree video for which the highest resolution data is sent. In this case, the processing system may request that the remote server lower the resolution of the highest resolution area of the 360 degree video, as long as the user can tolerate the lower resolution. User tolerances for resolution and other parameters of the XR experience may be specified in user profiles as described above.

Other actions may comprise modifying an audio component of the XR experience (e.g., adjusting directional audio output provided via multiple speakers and/or beamforming techniques, eliminating portions of the audio component, or replacing portions of the audio component with closed captioning). For instance, if high latency is causing the audio component of the XR experience to fail to properly synchronize with the visual component (e.g., an avatar of another user's mouth is moving, but the words the other user is speaking are not heard for a second or two after), then the processing system may request that a closed captioning track may be sent for display in place of playing the audio component.

Other aspects of the XR experience, including the presentation of tactile, olfactory, and/or gustatory components of the XR experience could also be scaled or limited to accommodate increasing latency in the network connection.

Furthermore, it will be appreciated that just as the processing system can take actions to scale the XR experience for increasing latency, the processing system may also take actions to scale the XR experience for decreasing latency. For instance, if the processing system determines, based on the latency that was measured in step 208, that the latency is improving, then the processing system may take actions to restore a previously scaled XR experience back to a default (e.g., by requesting an increase in the resolution of the visual component or by other actions).

In step 212, the processing system may display a visual indicator of the latency that was measured in step 208. In one example, the visual indicator may take the form of a graphic, such as a metronome, where different characteristics of the graphic can be varied to show different states of different parameters of the network connection between the processing system and the remote server.

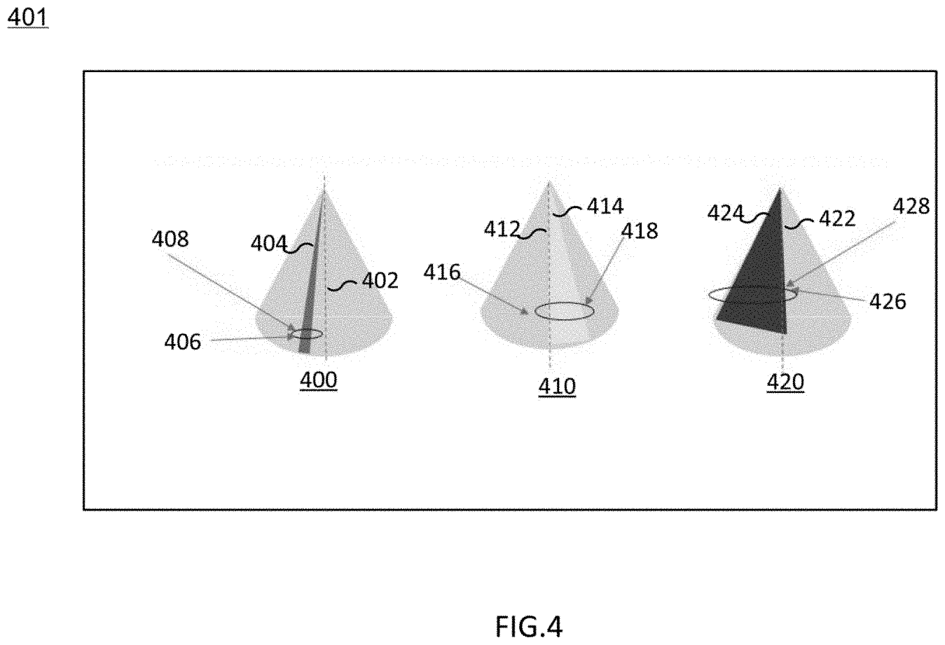

FIG. 4, for example, illustrates an example visual indicator for indicating connection latency that may be visualized as one or more metronomes 401. As illustrated, the metronome 400 may comprise an origin 402 (illustrated as ninety degree vertical line) and a pendulum 404. The origin 402 may represent the maximum latency that is tolerated for a given use (e.g., combination of user and XR application). Thus, the latency as visualized by the metronome 400 may increase from left to right. For instance, when the pendulum 404 is aligned with the origin 402, this may indicate that connection between the processing system and the remote server exactly (or nearly exactly) meets the minimum latency requirements for the given use. As the pendulum 404 moves to the left of the origin 402 (i.e., indicated by arrow 406), however, this may indicate a decrease in the latency of the connection (e.g., better conditions than the minimum latency requirements). Put another way, the lower the measured latency is, the further to the left the pendulum 404 is located. Conversely, the higher the latency, the further to the right the pendulum 404 is located. If the pendulum 404 is located anywhere to the right of the origin 402, this may indicate that the current measured latency is higher than can be tolerated for the given use.

In a further example, the width of the pendulum 404 (indicated by arrow 408) may be adjusted to also indicate the bandwidth of the connection that is required for the given use. In this case, as the bandwidth increases, the width of the pendulum 404 also increases. Thus, the width of the pendulum 404 is directly proportionate to the bandwidth.

In further examples, the metronome-style visual indicator could also be used to provide an indicator of device and application conditions. For instance, a metronome 410 may be used to visualize the content and compute conditions of the processing device for a given use. In this case, the metronome 410 may comprise an origin 412 (illustrated as ninety degree vertical line) and a pendulum 414. The origin 412 may represent the minimum content richness, or resolution, that is required for a given use and user (e.g., to render an XR application at a minimum resolution tolerated by the given user). Thus, the resolution of the rendered content as visualized by the metronome 410 may increase from left to right. For instance, when the pendulum 414 is aligned with the origin 412, this may indicate that the processing system is rendering the content at exactly (or nearly exactly) the minimum resolution required for the given use. As the pendulum 414 moves to the left of the origin 412, however, this may indicate that the processing system is rendering the content at a resolution that is lower than the minimum resolution required. Put another way, the lower the rendered resolution is, the further to the left the pendulum 414 is located. Conversely, the greater the rendered resolution, the further to the right the pendulum 414 is located (i.e., indicated by arrow 416). If the pendulum 414 is located anywhere to the right of the origin 412, this may indicate that the currently rendered resolution exceeds the minimum resolution required for the given use.

In a further example, the width of the pendulum 414 (indicated by arrow 418) may be adjusted to also indicate the amount of processing power required to render the content at the minimum required resolution. In this case, as the amount of processing power increases, the width of the pendulum 414 also increases. Thus, the width of the pendulum is directly proportionate to required processing power.

In further examples, a metronome 420 may be used to visualize the user experience and environment conditions of the processing device for a given use. In this case, the metronome 420 may comprise an origin 422 (illustrated as ninety degree vertical line) and a pendulum 424. The origin 422 may represent the minimum user experience metric that is required for a given use and user. The user experience metrics may be set manually by each user based on individual tolerances or may be collected automatically by the processing system based on sensor readings and/or user feedback. The particular user experience metrics that are required for a given use and user may vary by XR application, or the user experience metrics may be the same across all XR applications. In one example, the user experience metrics to set or collect may include metrics such as physiological metrics (e.g., heart rate, breathing rate, pupil dilation, other adrenal responses, etc.), indications of motion sickness or vertigo, and user sense of presence (e.g., a convincing feeling of being present in the XR world, or an ability to suspend disbelief).

In one example, the user experience metrics may be scaled based on the rendering capability of the user endpoint device's rendering capabilities, ability to handle XR stream bandwidth, and/or ability to provide convincing renderings. For instance, an XR headset from one vendor may be able to satisfactorily render a 1 Gbps data stream, whereas an XR headset from another vendor may only be able to satisfactorily render a 0.5 Gbps data stream.

Thus, the measure of the user experience metric of the rendered content as visualized by the metronome 420 may increase (or improve) from left to right. For instance, when the pendulum 424 is aligned with the origin 422, this may indicate that the processing system is rendering the content at exactly (or nearly exactly) the minimum user experience metric for the given use. As the pendulum 424 moves to the left of the origin 422, however, this may indicate that the processing system is rendering the content in a manner that delivers a lower measure of the user experience metric than the minimum required. Put another way, the lower the measure of the user experience metric is, the further to the left the pendulum 424 is located. Conversely, the greater the measure of the user experience metric, the further to the right the pendulum 424 is located (i.e., indicated by arrow 426). If the pendulum 424 is located anywhere to the left of the origin 422, this may indicate that the currently measured user experience metric does not meet the minimum measure of the user experience metric for the given use.

In a further example, the width of the pendulum 424 (indicated by arrow 428) may be adjusted to also indicate the measure of some environmental conditions of the XR experience (e.g., noise). In this case, as the measure of the environmental conditions increases, the width of the pendulum 424 also increases.

In further examples, further characteristics of the metronomes could be varied to indicate the conditions of the XR experience and/or the connection between the processing system and the remote server delivering the XR experience. For instance, the length of the pendulum could be varied to indicate the strength of the processing system's connection to a local WiFi router (e.g., the longer the pendulum, the stronger the connection). In another example, the speed of the pendulum's swing could be varied to indicate the current bandwidth of the connection (e.g., the faster the speed of the swing, the higher the bandwidth). In further examples, the color of the pendulum could be varied according to the severity of the latency conditions. For instance, a green pendulum could indicate that latency is well below a threshold, yellow could indicate that latency is close to or at the threshold, and red could indicate that the latency is greater than the threshold. Thus, the foregoing describes only a few examples of how the characteristics of the metronome-style visual indicator may be used to convey information about the XR experience to the user.

Referring back to FIG. 2, in optional step 214 (illustrated in phantom), the processing system may receive user feedback in response to at least one of: the presentation of the XR experience that was scaled (e.g., if the XR experience was scaled in step 210) and the visual indicator that was displayed in step 212. For instance, user feedback to the scaled presentation of the XR experience may comprise a verbal indication of the user's response to the scaled presentation (e.g., “That's much better” or “I'm still dizzy”), a signal received from the user via a user input device (e.g., pressing a button to indicate whether or not the user is comfortable with the scaled presentation), or another type of feedback. User feedback to the visual indicator may comprise an action taken by the user in response to the visual indicator, such as exiting the XR experience, requesting modification of the XR experience, making a purchase to improve the XR experience such as access to higher bandwidth, or other actions.

In optional step 216 (illustrated in phantom), the processing system may update a user profile based on the user feedback. For instance, as discussed above, a user profile may specify a user's tolerances for less than optimal network conditions when using various XR applications. Based on the user feedback, the processing system may be able to set a tolerance for an XR application for which no tolerance was previously available (e.g., cannot watch 360 degree video unless the latency is below x milliseconds) or may be able to update or refine an existing tolerance (e.g., the user said he could tolerate a latency below x milliseconds when using an XR gaming application, but his tolerance threshold appears closer to y seconds). The processing system may also be able to update the user profile to indicate modifications to XR applications under particular network conditions that successfully or unsuccessfully improved user comfort (e.g., the user does not mind playing an XR gaming application at a reduced resolution when the available bandwidth does not support higher resolution).

The method 200 may then return to step 204 and proceed as described above to continue to present and monitor the XR experience. Thus, the method 200 may iterate through steps 204-212 for the duration of the XR experience (e.g., until the XR experience comes to a scheduled end, until the user of the user endpoint device generates a signal to exit the XR experience, until the network connection conditions are determined not to support the XR experience at the level required by the application and user, etc.).

Thus, the method 200 provide a novel technique for a user endpoint device to measure the latency of a network connection between the user endpoint device and a remote device (e.g., application server) presenting an extended reality experience on the user endpoint device. The latency can be measured using unused portions of existing data structures and is therefore relatively simple to implement. Moreover, having an accurate measure of the latency may allow the user endpoint device to modify the XR experience when possible to compensate for the network conditions in a manner that is consistent with the unique requirements of the XR application and the tolerances of the user. Thus, physical user discomfort as a result of high latency or other network conditions affecting the XR experience can be minimized. Furthermore, by providing a unique visual indicator on a display of the user endpoint device to alert the user to the current network conditions, the user can easily pinpoint the causes of degradations in the XR experience.

The visual indicator can be displayed continuously on the display of the user endpoint device. Alternatively, the visual indicator could be hidden and displayed only when the user wishes to view the visual indicator, in order to avoid imposing on the XR experience.

In further examples, network service providers may provide the visual indicator as a service and could further enhance the indicator by providing opportunities for the purchase of additional network services. For instance, an edge device operated by the network service provider (such as one of the network elements 111A-111D of FIG. 1) could monitor ICMP traceroute packets exchanged between the processing system and the remote server in order to determine when an XR experience is being presented by the processing system and what the latency and other performance measures of the connection between the processing system and the remote server are during the presentation of the XR experience. If the user endpoint device is receiving less than adequate bandwidth for a particular XR application and user, the network service provider may provide an option to temporarily purchase increased bandwidth (e.g., x dollars for y minutes of increased bandwidth), access to another network slice with improved quality of service, or the like.

Although not expressly specified above, one or more steps of the method 200 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 2 that recite a determining operation or involve a decision do not necessarily require that both branches of the determining operation be practiced. In other words, one of the branches of the determining operation can be deemed as an optional step. However, the use of the term “optional step” is intended to only reflect different variations of a particular illustrative embodiment and is not intended to indicate that steps not labelled as optional steps to be deemed to be essential steps. Furthermore, operations, steps or blocks of the above described method(s) can be combined, separated, and/or performed in a different order from that described above, without departing from the examples of the present disclosure.

FIG. 5 depicts a high-level block diagram of a computing device specifically programmed to perform the functions described herein. For example, any one or more components or devices illustrated in FIG. 1 or described in connection with the method 200 may be implemented as the system 500. For instance, any of the user endpoint devices described in connection with FIG. 1 (such as might be used to perform the method 200) could be implemented as illustrated in FIG. 5.

As depicted in FIG. 5, the system 500 comprises a hardware processor element 502, a memory 504, a module 505 for presenting an XR experience with a visual latency indicator, and various input/output (I/O) devices 506.

The hardware processor 502 may comprise, for example, a microprocessor, a central processing unit (CPU), or the like. The memory 504 may comprise, for example, random access memory (RAM), read only memory (ROM), a disk drive, an optical drive, a magnetic drive, and/or a Universal Serial Bus (USB) drive. The module 505 for presenting an XR experience with a visual latency indicator may include circuitry and/or logic for performing special purpose functions relating to the operation of a user endpoint device for computing latency. The input/output devices 506 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like), or a sensor.

Although only one processor element is shown, it should be noted that the computer may employ a plurality of processor elements. Furthermore, although only one computer is shown in the Figure, if the method(s) as discussed above is implemented in a distributed or parallel manner for a particular illustrative example, i.e., the steps of the above method(s) or the entire method(s) are implemented across multiple or parallel computers, then the computer of this Figure is intended to represent each of those multiple computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computer or any other hardware equivalents, e.g., computer readable instructions pertaining to the method(s) discussed above can be used to configure a hardware processor to perform the steps, functions and/or operations of the above disclosed method(s). In one example, instructions and data for the present module or process 505 for presenting an XR experience with a visual latency indicator (e.g., a software program comprising computer-executable instructions) can be loaded into memory 504 and executed by hardware processor element 502 to implement the steps, functions or operations as discussed above in connection with the example method 200. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for presenting an XR experience with a visual latency indicator (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

While various examples have been described above, it should be understood that they have been presented by way of example only, and not limitation. Thus, the breadth and scope of a preferred example should not be limited by any of the above-described example examples, but should be defined only in accordance with the following claims and their equivalents.

What is claimed is:

1. A method comprising:
receiving, by a processing system including at least one processor, an extended reality stream from a remote server over a network connection;
presenting, by the processing system, an extended reality experience to a user endpoint device by playing back the extended reality stream;
measuring, by the processing system, a latency of the network connection between the processing system and the remote server; and
displaying, by the processing system, a visual indicator of the latency that was measured on a display of the user endpoint device.

2. The method of claim 1, wherein the measuring comprises:
sending, by the processing system, an outbound enhanced internet control message protocol traceroute message to the remote server, wherein the outbound enhanced internet control message protocol traceroute message includes a field containing a first timestamp indicating a time at which the outbound enhanced internet control protocol traceroute message was sent;
receiving, by the processing system in response to the outbound enhanced internet control message protocol traceroute message, a return enhanced internet control message protocol traceroute message from the remote server, wherein the return enhanced internet control message protocol traceroute message includes a field containing a second timestamp indicating a time at which the remote server sent the return enhanced internet control message protocol traceroute message; and
calculating the latency from a time difference between the first timestamp and the second timestamp.

3. The method of claim 1, wherein the visual indicator comprises a graphic in a form of a metronome.

4. The method of claim 3, wherein the metronome comprises:
an origin representing a maximum latency that is tolerated for the extended reality experience; and
a pendulum, wherein a location of the pendulum relative to the origin represents how close the latency that is measured is to the maximum latency that is tolerated.

5. The method of claim 4, wherein a width of the pendulum is directly proportionate to a bandwidth of the network connection between the processing system and the remote server.

6. The method of claim 4, wherein a color of the pendulum represents how close the latency that is measured is to the maximum latency that is tolerated.

7. The method of claim 4, wherein the maximum latency that is tolerated for the extended reality experience is specific to a user of the user endpoint device.

8. The method of claim 7, wherein the maximum latency that is tolerated for the extended reality experience is stored in a profile for the user.

9. The method of claim 8, further comprising:
receiving, by the processing system, feedback from the user in response to the displaying the visual indicator; and
updating, by the processing system, the profile for the user based on the feedback.

10. The method of claim 9, wherein the feedback comprises a request from the user to exit or modify the extended reality experience.

11. The method of claim 1, further comprising:
scaling, by the processing system, the presenting of the extended reality experience in response to the latency that is measured when the latency that is measured is greater than a predefined threshold latency.

12. The method of claim 11, wherein the scaling comprises:
requesting, by the processing system, that network traffic between the processing system and the remote server be rerouted to a route experiencing a lower latency.

13. The method of claim 11, wherein the scaling comprises:
lowering, by the processing system, a resolution of a visual component of the extended reality experience.

14. The method of claim 11, wherein an action to be taken in accordance with the scaling is defined in a profile for a user of the user endpoint device.

15. The method of claim 14, further comprising:
receiving, by the processing system, feedback from the user in response to the scaling; and
updating, by the processing system, the profile for the user based on the feedback.

16. The method of claim 1, further comprising:
displaying, by the processing system, a visual indicator of a resolution of a visual component of the extended reality experience.

17. The method of claim 16, where the visual indicator of the resolution takes a form of a metronome comprising:
an origin representing a minimum resolution that is tolerated for the extended reality experience; and
a pendulum, wherein a location of the pendulum relative to the origin represents how close an actual resolution of the extended reality experience is to the minimum resolution that is tolerated.

18. The method of claim 17, wherein a width of the pendulum is directly proportionate to an amount of processing power required to render the extended reality experience at the minimum resolution that is tolerated.

19. A non-transitory computer-readable medium storing instructions which, when executed by a processing system, cause the processing system to perform operations, the operations comprising:
receiving an extended reality stream from a remote server over a network connection;
presenting an extended reality experience to a user endpoint device by playing back the extended reality stream;
measuring a latency of the network connection between the processing system and the remote server; and
displaying a visual indicator of the latency that was measured on a display of the user endpoint device.

20. A device comprising:
a processor; and
a computer-readable medium storing instructions which, when executed by the processor, cause the processor to perform operations, the operations comprising:
receiving an extended reality stream from a remote server over a network connection;
presenting an extended reality experience to a user endpoint device by playing back the extended reality stream;
measuring a latency of the network connection between the processing system and the remote server; and
displaying a visual indicator of the latency that was measured on a display of the user endpoint device.
